(19) United States
(12) Patent Application Publication
(10) Pub. No.: US 2002/0176213 A1
(43) Pub. Date: Nov. 28, 2002

(54) Magnetoresistive head

(76) Inventors: Satoshi Ajiki, Yamagata (JP); Koichi Hosoya, Yamagata (JP)

Correspondence Address: LAW OFFICES, WHITHAM, CURTIS & CHRISTOFFERSON, P.C., 11491 SUNSET HILLS ROAD, SUITE 340, P.O. BOX 9204, RESTON, VA, 20190, US

(21) Appl. No.: 10/151,916

(22) Filed: May 22, 2002

(30) Foreign Application Priority Data
May 23, 2001 (JP) P.2001-153456

(51) Int. Cl. G11B 5/39

(52) U.S. Cl. 360/313; 360/122

(57) ABSTRACT

A non-magnetic layer is integrated with a magnetoresistive element to form a scanning surface which is slid on a magnetic recording medium. The non-magnetic layer made of a material having a hardness higher than a hardness of Al₂O₃. Such hardness is represented by a Vickers hardness in a range of 8 GPa to 18 GPa.

### BACKGROUND OF THE INVENTION

The present invention relates to a magnetoresistive head provided with a magnetoresistive element as a magnetic sensitive element.

A magnetoresistive head (hereinafter called an MR head) provided with a magnetoresistive element (hereinafter called an MR element) as a magnetic sensitive element has been utilized as a magnetic head dedicated for reproduction which detects a magnetic signal recorded on a magnetic recording medium such as a magnetic tape, a magnetic disk, for example. The MR element is arranged in a manner that bias layers, electrode layers etc. are disposed at the both end portions of a magnetoresistive film which electric resistance value changes in accordance with external magnetic field.

An MR head is configured in a manner that an MR element is disposed at a position where signal magnetic field is applied from a magnetic recording medium and voltage change at the MR element is detected while supplying a sense current to the MR element. Thus, it is possible to detect a magnetic signal recorded on the magnetic recording medium.

As shown in FIG. 3, a related-art MR head 100 has a configuration that an MR element 101 is sandwiched between a lower magnetic shield layer 103 and an upper magnetic shield layer 104 through non-magnetic layers 102 formed by alumina (Al₂O₃). In this respect, FIG. 3 is an enlarged diagram showing the end surface of a main portion of the MR head 100 which is viewed from a surface side of the MR head opposing to a magnetic recording medium (hereinafter called a scanning surface).

The MR element 101 is configured by a magnetoresistive film 110 (hereinafter called an MR film 110) which is restricted to have a predetermined width (track width) at the scanning surface, a pair of bias layers 111 disposed at the both end portions of the MR film 110, and a pair of electrode layers 112 disposed on the bias layers 111, respectively.

According to the MR head 100 configured in this manner, the distance between the lower magnetic shield layer 103 and the upper magnetic shield layer 104 becomes a reproduction gap length. The reproduction gap length becomes a cause for determining the minimum magnetic signal capable of being reproduced in the MR head 100 and largely influences on the reproduction characteristics.

The aforesaid MR heads have been mounted on hard disk driving apparatuses etc. and employed as heads which slide above magnetic recording media upon recording/reproducing while not being contacted therewith, that is, floating type heads. However, in recent years, the MR heads have been mounted on tape type recording/reproducing apparatuses such as tape streamer apparatuses etc. In this respect, since the tape streamer apparatus is arranged that a magnetic tape as a magnetic recording medium slides at a high speed on the surface of the MR head opposing to the magnetic tape, there arises a problem that influence due to the friction caused on the scanning surface of the MR head becomes remarkable.

To be more concrete, for example, on the scanning surface of the MR head 100, there arises such a phenomenon that the metal layers forming the magnetic shield layers 103, 104, the bias layer 111 and the electrode layer 112 slide on the magnetic tape and some of these layers is dragged and abraded as shown by the symbol B in FIG. 3, whereby the respective portions constituting the MR head 100 may be electrically or magnetically short-circuited.

In this manner, for example, when the MR element 101 is electrically short-circuited with the magnetic shield layers 103, 104, the sense current supplied to the MR film 110 through the electrode layers 112 becomes unstable and so it becomes difficult to obtain good reproduction output. Further, for example, when the MR element 101 is magnetically short-circuited with the magnetic shield layers 103, 104, it becomes impossible to apply suitable bias magnetic field to the MR film 110 from the bias layers 111. Thus, there arises such a phenomenon that spike noise is generated due to the movement of magnetic domain wall, so that the reproduction characteristics is degraded.

### SUMMARY OF THE INVENTION

The invention has been made in view of the aforesaid related-art circumstance and an object of the invention is to provide a magnetoresistive head exhibiting good reproduction characteristics stably.

In order to achieve the above object, according to the present invention, there is provided a magnetoresistive head, comprising:

a magnetoresistive element; and

a non-magnetic layer, integrated with the magnetoresistive element to form a scanning surface which is slid on a magnetic recording medium, the non-magnetic layer made of a material having a hardness higher than a hardness of Al₂O₃.

In the magnetoresistive head, the degree of the grinding action caused at the scanning surface of the head is reduced and so the metal dragging and abrading phenomenon caused at the scanning surface can be suppressed.

Therefore, the respective portions at the scanning surface are prevented from being electrically or magnetically short-circuited and so good reproduction output can be obtained stably. Accordingly, it becomes possible to provide a suitable magnetoresistive head when the magnetoresistive head is mounted in use on a tape type recording and reproducing apparatus such as a tape streamer apparatus etc.

### BRIEF DESCRIPTION OF THE DRAWINGS

In the accompanying drawings:

FIG. 1 is a schematic diagram of a magnetoresistive head (MR head) according to one embodiment of the invention, viewed from a scanning surface side thereof;

FIGS. 2A and 2B are sectional diagrams respectively showing the MR heads according to the invention and a related-art MR head at portions near scanning surfaces thereof at the time where tape sliding tests were performed for these heads; and

FIG. 3 is a schematic diagram of the related-art head viewed from a scanning surface side thereof.

### DETAILED DESCRIPTION OF THE PREFERRED EMBODIMENTS

One preferred embodiment of the invention will be explained in detail with reference to the accompanying drawings.

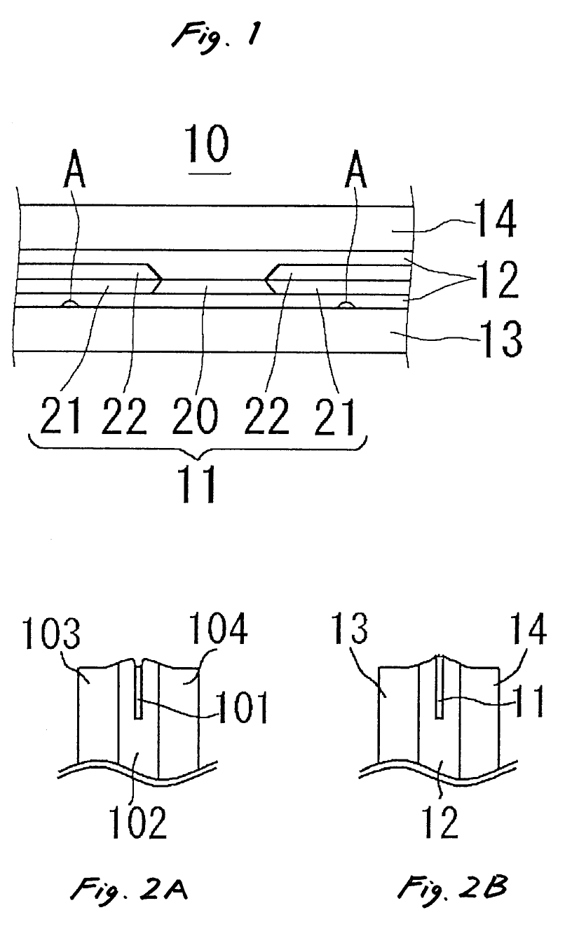

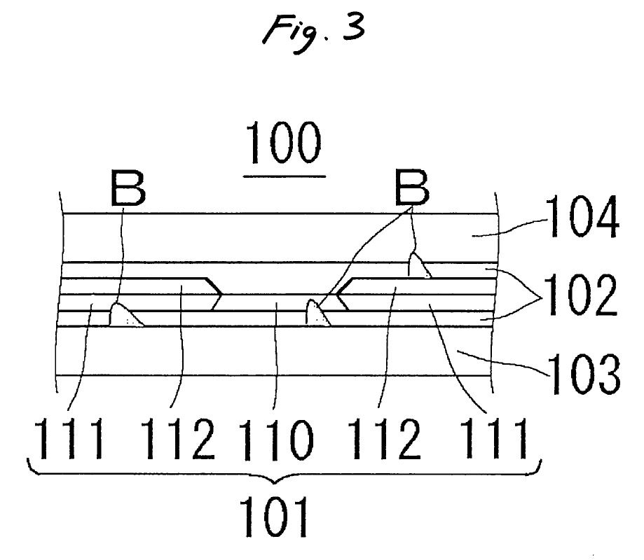

As shown in FIG. 1, the a magnetoresistive head 10 (hereinafter called an MR head 10) has a configuration that an MR element 11 is sandwiched between a lower magnetic shield layer 13 and an upper magnetic shield layer 14 through non-magnetic layers 12.

The MR element 11 is configured by a magnetoresistive film 20 (hereinafter called an MR film 20) which is restricted to have a predetermined width (track width) at its surface opposing to the magnetic tape (hereinafter, called a scanning surface), a pair of bias layers 21 disposed at the both end portions of the MR film 20, and a pair of electrode layers 22 disposed on the bias layers 21, respectively.

The MR film 20 exhibits the magnetoresistive effect that its resistance value changes in accordance with external magnetic field. In the MR head 10, magnetic field from a magnetic signal recorded on a magnetic tape is applied to the MR film 20 as the external magnetic field. The MR head 20 is configured in a manner that voltage change is detected based on a sense current supplied to the MR film 20 through the electrode layers 22 to detect the magnetic signal recorded on a magnetic tape thereby to perform the reproduction.

Incidentally, the MR film 20 is formed in a not-shown three-layer structure including a magnetoresistive film formed by NiFe, for example, a magnetic separation film formed by non-magnetic material of Ta, for example, and a lateral bias film, formed by CoZrMo, for example, for applying lateral bias to the magnetoresistive film.

Each of the bias layers 21 is formed by high-coercive magnetic material of CoCrPt, for example, and has a function of applying vertical bias magnetic field to the MR film 20. In the MR head 10, the MR film 20 is placed in a single domain state and controlled in its magnetic characteristics by the bias layers 21. For example, the MR film 20 is prevented from causing such a phenomenon that its magnetic domain wall moves, so that its good output characteristics can be secured. Further, each of the electrode layers 22 is formed by electrical conductive material of Au, for example, and has a function of supplying the sense current to the MR film 20.

Each of the non-magnetic layers 12 of the MR head 10 is formed by non-magnetic non-conductive material exhibiting higher hardness as compared with Al₂O₃ employed in the related-art MR head 100.

Each of the lower magnetic shield layer 13 and the upper magnetic shield layer 14 is formed by hard magnetic material such as CZT (CoZtTa), for example. Each of the lower magnetic shield layer 13 and the upper magnetic shield layer 14 has a function of taking into the magnetic field not to be reproduced of the magnetic field generated from a magnetic signal recorded on a magnetic tape and introducing only the magnetic field to be reproduced into the MR element 11. That is, in the MR head 10, the distance between the lower magnetic shield layer 13 and the upper magnetic shield layer 14 becomes a reproduction gap length.

According to the MR head 10 configured in the aforesaid manner, since the non-magnetic layers 12 are formed by the material exhibiting higher hardness as compared with Al₂O₃, it is possible to reduce the generation degree of particles at the scanning surface due to the sliding operation on a magnetic tape. Thus, in the MR head 10, the degree of grinding function caused at the scanning surface can be reduced as compared with the related-art MR head 100, whereby the metal dragging and abrading phenomenon caused at the scanning surface can be suppressed.

Accordingly, the MR head 10 can be prevented from being electrically or magnetically short-circuited at the respective portions of the scanning surface thereof, and so the life time of the head can be made longer and further stable and good reproduction characteristics can be secured.

In this respect, the non-magnetic non-conductive material suitable for use as the non-magnetic layers 12 may be DLC (diamond like carbon), SiC, SiO₂, or Si—Al—O—N—Y, for example. The non-magnetic layer may be formed by using one or more of these material.

The non-magnetic layers 12 are desired to be formed by DLC, in particular. This is because, although Vickers hardness of Al₂O₃ used in the non-magnetic layers 102 of the related-art MR head 100 is 6.9 GPa, DLC has a quite high hardness that Vickers hardness thereof is about 14.7 GPa. Further, DLC has a smaller coefficient of dynamic friction as compared with Al₂O₃. Thus, when the non-magnetic layers 12 are formed by using DLC, the generation degree of particles caused at the scanning surface of the non-magnetic layers due to the sliding operation of the non-magnetic layers 12 on a magnetic tape can be reduced to a large extent. As a result, the metal dragging and abrading phenomenon caused at the scanning surface can be suppressed and also the sliding characteristics between the magnetic tape and the MR head 10 can be improved.

Incidentally, Vickers hardness of the non-magnetic layers 12 at the time of forming them by DLC differs depending on the film forming condition of DLC and exhibits a value almost in a range of 8 GPa to 18 GPa.

Further, Si—Al—O—N—Y exhibits excellent heat-resistance characteristics as well as high hardness. Thus, the non-magnetic layers 12 may be formed by Si—Al—O—N—Y.

Next, hereinafter, the explanation will be made as to the case where the aforesaid MR head 10 was actually fabricated and the tape sliding test was made as to the MR head. The non-magnetic layers 12 of the MR head 10 thus fabricated was formed by DLC. The MR head 10 thus fabricated was attached to a fixed head and a magnetic tape was slid for 720 hours at a relative speed of 5 m/sec between the magnetic tape and the MR head. Further, as a comparative subject, the MR head 100 with the related-art structure having the non-magnetic layers 102 formed by Al₂O₃ was fabricated and the tape sliding test was performed as to this MR head in the similar manner.

As a result of the tape sliding tests thus performed, it was confirmed that the MR head 10 having the non-magnetic layers 12 formed by DLC is more reduced in an abrasion amount of each of the element 20, the bias layers 21 and the electrode layers 22 as well as an abrasion amount of the non-magnetic layers 12 as compared with those in the related-art MR head 100. The MR head 10 thus fabricated was suppressed to a large extent in the metal dragging and abrading phenomenon caused at the scanning surface as shown by the symbol A in FIG. 1 as compared with the related-art MR head 100. Further, in the MR head 10, since the non-magnetic layers 12 were fabricated by DLC having a smaller coefficient of dynamic friction as compared with Al₂O₃, the sliding characteristics of the MR head with respect to the magnetic tape was improved.

In the related-art MR head 100, as shown in FIG. 2A, recession phenomenon was appeared that the MR film 101 recessed from the scanning surface at the reproduction gap portion between the lower magnetic shield layer 103 and the upper magnetic shield layer 104. In contrast, according to the MR head 10 having the non-magnetic layers 12 formed by DLC, as shown in FIG. 2B, it was confirmed that the degree of the recession phenomenon caused at the reproduction gap portion was suppressed to a large extent. Further, in the related-art MR head 100, there appeared such phenomenon that metal pieces generated by being scraped due to the friction between the magnetic tape and the MR head clogged at the recess portion. In contrast, such phenomenon did not appear in the MR head 10.

The reason why the recession phenomenon appears at the reproduction gap portion in the related-art MR head 100 as shown in FIG. 2A is considered that particles are generated when the magnetic tape slides on the non-magnetic layers 102 at the scanning surface thereof, for example, and the particles act as abrasive material thereby to grind the scanning surface.

In the MR head 10 thus having been subjected to the tape sliding tests in the aforesaid manner, it was confirmed that the scanning surface protrudes at a position near the reproduction gap portion by about 5 nm to 20 nm in comparison with the related-art MR head 100. An amount of the protrusion near the reproduction gap portion was checked as to each of plural sample heads in which the non-magnetic layers 12 with different hardness were formed by varying the film forming condition of DLC. As a result, it was determined that an amount of the protrusion changes depending on the hardness of DLC.

The invention is not limited in its application to the MR head 10 configured as shown in FIG. 1 but also applicable to various types of MR heads each provided with an MR element as a magnetic sensitive element. For example, the invention may be applied to a hybrid type magnetic head which is formed by integrating an inductive type recording magnetic head at the upper portion of the MR head 10 shown in FIG. 1.

What is claimed is:

1. A magnetoresistive head, comprising:
a magnetoresistive element; and
a non-magnetic layer, integrated with the magnetoresistive element to form a scanning surface which is slid on a magnetic recording medium, the non-magnetic layer made of a material having a hardness higher than a hardness of Al₂O₃.

2. The magnetoresistive head as set forth in claim 1, wherein the material forming the non-magnetic layer at least one material selected from a group including DLC, SiC, SiO₂ and Si—Al—O—N—Y.

3. A magnetoresistive head, comprising:
a magnetoresistive element; and
a non-magnetic layer, integrated with the magnetoresistive element to form a scanning surface which is slid on a magnetic recording medium, the non-magnetic layer made of a material having a Vickers hardness in a range of 8 GPa to 18 GPa.

4. The magnetoresistive head as set forth in claim 3, wherein the material forming the non-magnetic layer at least one material selected from a group including DLC, SiC, SiO₂ and Si—Al—O—N—Y.
